(19) United States
(12) Patent Application Publication
(10) Pub. No.: US 2006/0280889 A1
(43) Pub. Date: Dec. 14, 2006

(54) Tubular nylon alloy members for tubing and hose constructions

(76) Inventors: Steven M. Powell, Chardon, OH (US); Nick A. Martino, N. Canton, OH (US); James L. Johnston, N. Canton, OH (US); William C. Fisher, Cuyahoga Falls, OH (US)

Correspondence Address: John A. Molnar, Jr.;PARKER-HANNIFIN CORPORATION, 6035 Parkland Boulevard, Cleveland, OH, 44124-4141, US

(21) Appl. No.: 11/331,964

(22) Filed: Jan. 13, 2006

Related U.S. Application Data
(60) Provisional application No. 60/689,220, filed on Jun. 10, 2005.

(51) Int. Cl. B32B 1/08

(52) U.S. Cl. 428/36.91; 428/36.9

(57) ABSTRACT

Tubular polymeric member for articles such as tubing and hoses. The member is formed of an alloy which is a blend of a polyamide and a polyolefin, and a compatibilizing copolymer.

### CROSS-REFERENCE TO RELATED CASES

The present application claims the benefit of the filing date of U.S. Provisional Application Ser. No. 60/689,220, filed Jun. 10, 2005, the disclosure of which is expressly incorporated herein by reference.

### BACKGROUND OF THE INVENTION

The present invention relates broadly to tubular nylon alloy members and to articles such as hoses and tubing, which may be straight or coiled, constructed thereof, and more particularly to such members and to such articles for airbrake tubing.

Tractor/trailer rigs and other heavy-duty vehicles are conventionally are equipped with pneumatically-operated emergency brakes in addition to usual service airbrakes. In basic operation, and as is further described in U.S. Pat. No. 5,232,645 and U.K. Pat. Appln. GB 2,239,503, pressurized air is supplied from the truck unit to the trailer unit, which may be articulated, for the actuation of the emergency and service brake systems of the trailer. Within the emergency brake system, the braking mechanism normally is released under the condition of a constant air pressure supply. The service brake system, however, is manually actuated with pressurized air being supplied to the breaking mechanism upon the Appln. of the brake pedals by the operator.

Pressurized air from the truck to the trailer unit, or between trailer units in tandem rigs, may be supplied via flexible tubing or hose, with separate, dedicated lines being provided for the independent operation of the emergency and service brake systems. Performance requirements for airbrake tubing generally are subject to various governmental or industry regulations promulgated to ensure the safe operation of the vehicle. In this regard, airbrake tubing conventionally is constructed as having tubular core which optionally may be surrounded, in certain tubing types, by one or more layers of a braided or other wound reinforcement. The core tube may be a thermoplastic material such as a polyamide, polyolefin, polyvinyl chloride, or polyurethane, or a synthetic rubber material such as Buna N or neoprene, with the optional reinforcement preferably being a nylon, polyester, or aramid filament or yarn. For increased abrasion resistance, the core tube and, as the case may be, reinforcement typically are covered with an outer jacket which may be formed of the same or different material as the core tube, but preferably is formed of more abrasion-resistance polymeric material which may be a polyamide, polyolefin, polyvinyl chloride, or polyurethane. Representative airbrake and other tubing constructions, and coils and bundles formed of such tubing, are described in U.S. Pat. Nos. 6,776,195; 6,670,004; 6,576,312; 6,098,666; 6,071,579; 6,066,377; 5,392,541; 5,232,645; 4,653,541; 4,009,734; 3,977,440; and RE38,087, U.S. Pat. Appln. Publs. 2004/0134555; 2004/005811; and 2003/0145896, and U.K. Pat. Appln. 2,239,503. Commercial airbrake tubing and coils are manufactured and sold by the Parflex Division of Parker-Hannifin Corp., Ravenna, Ohio.

Other multi-layer tubing constructions, such as used for fuel line applications, incorporate a bonding or tie layer between an inner fluoropolymer layer or liner and a second layer of a stronger, tougher, and, typically, less-expensive material, such as a nylon, polyamide, or polyurethane, which is used as a reinforcement or cover for the liner. The tie layer, which may be formed as a co- or tri-extrusion with the liner and second layers, is formulated to be compatible chemically with both the fluoropolymer material of the liner and the material of the second layer such that a thermal fusion bond may be achieved between the liner and tie layer and the tie layer and second layer to thereby consolidate the tubing into an integral structure. The use of such tie layers dictates the selection of specific materials for the liner and second layer so as to be compatible with the material of the tie layer, or vice versa, and is believed limited to the use of melt processible fluoropolymers such as polyvinylidene fluoride (PVDF) or ethylene tetraflurorethylene (ETFE).

Multi-layer tubing constructions in general are shown in commonly-assigned U.S. Pat. No. 6,776,195. Other constructions are shown in U.S. Pat. Nos. 6,066,377; 6,041,826; 6,039,085; 6,012,496; 5,996,642; 5,937,911; 5,891,373; 5,884,672; 5,884,671; 5,865,218; 5,743,304; 5,716,684; 5,678,611; 5,570,711; 5,566,720; 5,524,673; 5,507,320; 5,500,263; 5,480,271; 5,469,892; 5,460,771; 5,419,374, 5,383,087; 5,284,184; 5,219,003; 5,167,259; 5,167,259; 5,112,692; 5,112,692; 5,093,166; 5,076,329; 5,076,329; 5,038,833; 5,038,833; 4,706,713; 4,627,844; and 3,561,493, in German Pat. Publ. Nos. DE 4001126; 3942354; and 3921723; and 3821723, in Japanese Pat. Publ. Nos. JP 61171982; 4224939; and 140585, in Europe Pat. Publ. Nos. EP 1002980, 992518, and 551094, in International (PCT) Publ. Nos. WO 99/41538; 99/41073; 97/44186; and 93/21466, and in U.K. Pat. Publ. No. GB 2204376.

It is believed that alternative single and multi-layer tubular polymeric members would be useful for airbrake tubing applications, and in a variety of other fluid transfer and motion control applications. In this regard, in severe or even normal service environments, such as in mobile or industrial pneumatic or hydraulic applications, hoses and tubing of the type herein involved may be exposed to a variety of environmental factors and mechanical stresses that cannot always be predicted. It is anticipated, therefore, that tubing and hose constructions which offer comparable performance, but which are more economical would be well-received by numerous industries.

### BROAD STATEMENT OF THE INVENTION

The present invention is directed to tubular polymeric members, which may formed by extrusion, co-extrusion, or molding, and articles such as single or multi-layer tubing and hoses, which may be straight or coiled, constructed thereof. More particularly, the invention is directed to such members which are formed of an alloy or alloy-like blend of a more chemically-resistant thermoplastic polymeric material, namely a polyamide such as Nylon 11 or 12, and a more economical thermoplastic polymeric material, namely a polyolefin such as a high density polyethylene. These materials may be admixed to form a homogenous blend using a compatibilizer which may be a graft or other copolymer of a polyolefin and a polyamide.

The result is a synergistic combination of the two materials, each imparting unique benefits to the alloy material which behaves as one material. As formed into tubing and used in the articles of the invention, such tubing and articles exhibit performance which is comparable to that of tubing formed entirely of a polyamide such as Nylon 11 or 12, but at a lower cost. Such tubing and articles, moreover, may be formed to exhibit low temperature flexibility and cold temperature impact resistance which is improved over that of Nylon 11 or 12 constructions, and to have a lower coefficient of friction for easier installation of long tubing or hose lengths in confined spaces, such as in the rigging of tractor-trailers. In such tubing and articles, the alloy material also reduces migratory extrudation of oligomers which may be exhibited by plasticized Nylon 11 grades, with an attendant improvement in long-term flexibility and directional stability for reduced leakage. Advantageously, as compared to traditional Nylon grades such as 6, 6/66, 6/12. 11, and 12, the compatibilizer reduces shear and improves lubrication for increased extrusion processing speeds of the alloy material of the invention in the fabrication of the tubing and articles. Should the burst strength of such tubing and articles require improvement, additional or stronger yarns, or added layers thereof may be used in reinforced construction. In non-reinforced constructions, the alloy tubing of the invention may be laminated in a multi-layer construction with a stiffer material such as a nylon.

The tubing members formed of the alloy material of the invention may be particularly adapted for use as single or multi-layer tubing for vehicular airbrake systems, and/or as a core tube or other element in a reinforced tubing and hose constructions, as well as in other applications requiring chemical resistance and/or compliance with industry or governmental standards. Typically in such constructions, the more chemically or environmentally-resistant layers such as the tubing member of the invention are provided as an innermost and/or outermost layer of the structure. In reinforced constructions, such member may be used as a core tube over which one or more layers of a fibrous reinforcement layer are braided or wound to provide resistance to internal or external pressures. Alternatively, such member may be used as an outer layer over the reinforcement layers.

The present invention, accordingly, comprises the materials and the articles constructed which are exemplified in the detailed disclosure to follow. Advantages of the present invention include a tubular polyamide alloy member which may be used alone as tubing or as core tube for hose, and which provides improved low temperature flexibility and cold temperature impact resistance with a lower coefficient of friction, and a reduction in reduces migratory extrudation of oligomers which is sometimes observed in plasticized Nylon 11 grades. The long-term flexibility and directional stability is also improved for a reduced leakage potential. Additional advantages include a tubing construction which is economical to manufacture, and which meets applicable DOT and SAE standards for airbrake tubing and coils such as SAE Standard J844, “Nonmetallic Air Brake System Tubing,” (June 1998), SAE Standard J2484, “Push-To-Connect Tube Fittings for Use in the Piping of Vehicular Air Brake,” (May 2000), and SAE Standard J1131, “Performance Requirements for SAE J844 Nonmetallic Tubing and Fitting Assemblies Used in Automotive Air Brake Systems,” (August 1998), and NHSA/DOT FMVSS 106 (49 CFR § 571.106). These and other advantages should be apparent to those skilled in the art based upon the disclosure contained herein.

### BRIEF DESCRIPTION OF THE DRAWINGS

For a fuller understanding of the nature and objects of the invention, reference should be had to the following detailed description taken in connection with the accompanying drawings wherein:

FIG. 1 is a side elevational view of a single layer tubing member according to the present invention;

FIG. 2 is a side elevational, cut-away view of a representative multi-layer tubing construction according to the present invention; and

FIG. 3 is a side elevational view, cut-away view of a representative three layer reinforced tubing construction according to the present invention.

The drawings will be described further in connection with the following Detailed Description of the Invention.

### DETAILED DESCRIPTION OF THE INVENTION

Certain terminology may be employed in the description to follow for convenience rather than for any limiting purpose. For example, the terms “forward,” “rearward,” “right,” “left,” “upper,” and “lower” designate directions in the drawings to which reference is made, with the terms “inward,” “interior,” “inner,” or “inboard” and “outward,” “exterior,” “outer,” or “outboard” referring, respectively, to directions toward and away from the center of the referenced element, and the terms “radial” or “horizontal” and “axial” or “vertical” referring, respectively, to directions, axes, planes perpendicular and parallel to the central longitudinal axis of the referenced element. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows.

For the illustrative purposes of the discourse to follow, the precepts of the tubular polymeric member of the invention herein involved are described in connection with its utilization as flexible tubing, which may be straight or coiled, such as for vehicular airbrake applications. It will be appreciated, however, that aspects of the present invention may find use in other tubing applications, such as in multiple tube bundles or as a core tube or other member within a flexible pressure or vacuum hose construction such as for hydraulic or pneumatic power, signaling, control, or general fluid transfer applications. Use within those such other applications therefore should be considered to be expressly within the scope of the present invention.

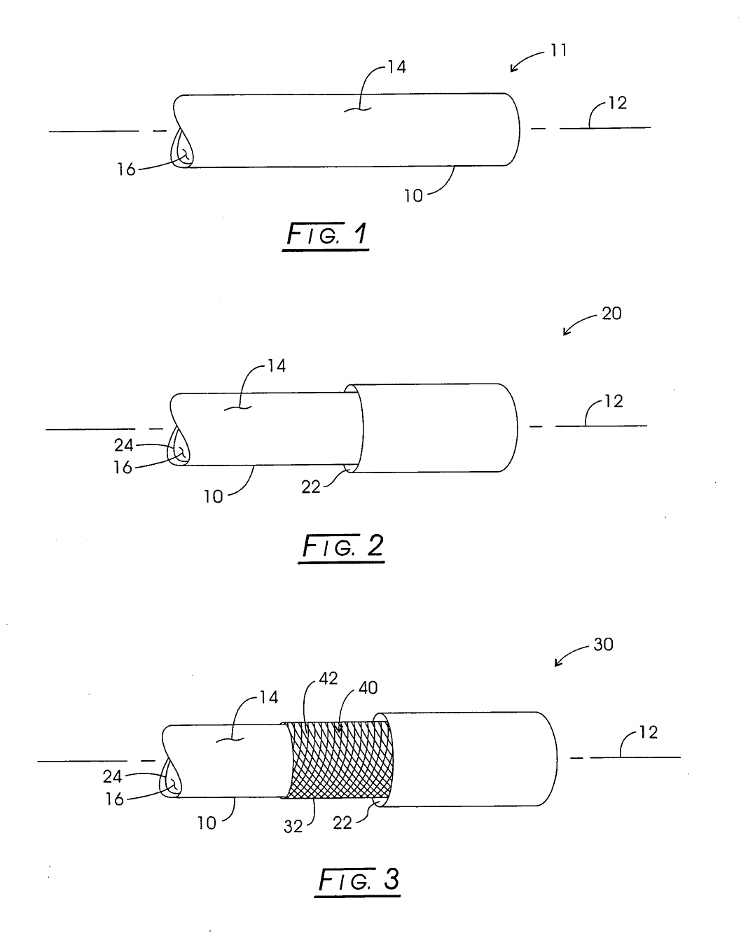

Referring then to the figures wherein corresponding reference characters are used to designate corresponding elements throughout the several views with equivalent elements being referenced with prime or sequential alphanumeric designations, a representative tubular polymeric member, 10, in accordance with the present invention is referenced generally at 11 in FIG. 1 as a length of a single layer tubing construction. In such tubing construction 11, member 10, which may be straight as shown or coiled, extends lengthwise along a central longitudinal axis, 12. In the embodiment shown, member 10 has a circumferential outer surface, 14, and a circumferential inner surface, 16.

Member 10 may be extruded or otherwise fabricated, such as by molding, of an alloy compounded as a blend of a first thermoplastic material which is a polyamide or a polyamide copolymer, a second thermoplastic material which is a polyolefin or a polyolefin copolymers thereof, and a compatibilizer which is a copolymer of a polyamide and a polyolefin. As used herein, the term “thermoplastic material” may be used interchangeably with “melt processible material,” and is in contrast to non-melt processible materials such as thermosets or non-thermosetting materials which otherwise exhibit a melt viscosity that is sufficiently high so as to preclude flow and processing by conventional melt extrusion or molding operations, and therefore necessitating that the material be processed using sintering or solvent processing techniques. Such materials, which may be referred herein as “resins,” typically will have a melting point of between about 110-230° C., and a thermal decomposition temperature, which defines the upper processing limit of the resin, of between about 150-260° C. As also used herein, “melting point” may be a transition from a form-stable crystalline or glassy solid phase to a softened or otherwise viscous phase which may be generally characterized as exhibiting intermolecular chain rotation and, as between layers, chain diffusion and/or other intermingling. For amorphous or other thermoplastic resins not having a clearly defined melting peak, the term melting point is used interchangeably with glass transition or softening point.

The first and second thermoplastic materials, as well as the compatibilizer, themselves may be blends, such as in the case of the first and second thermoplastic materials, of a blend of one or more homopolymers, one or more copolymers, or one or more homopolymers and one or more copolymers, and in the case of the compatibilizer, of a blend of copolymers. Also, the alloy itself may be may be unfilled or, alternatively, compounded with one or more fillers, modifiers, or other additives. Such additives, which may be in liquid, powder, particulate, flake, fiber, or other form, may include electrically-conductive fillers, microwave-attenuating fillers, thermally-conductive fillers, lubricants, wetting agents, stabilizers, antioxidants, pigments, dyes, colorants, colorings, or opacifying agents such as for coloring-coding of the tubing, luminescents, light reflectants, chain extending oils, tackifiers, blowing agents, foaming or anti-foaming agents, reinforcements such as glass, carbon, or textile fibers, and fire retardants such as halogenated compounds, metal oxides and salts, intercalated graphite particles, borates, siloxanes, phosphates, glass, hollow or solid glass or elastomeric microspheres, silica, silicates, mica, and the like. Typically, the additives are blended or otherwise admixed with the base material, and may comprise between about 0.1% and 80% or more by total volume of the formulation. An especially preferred modifier for improved heat resistance is polybutylene terephthalate (PBT).

As to the polyamide of the first thermoplastic material, for airbrake tubing applications a polyamide of the type commonly used in such applications, such as a plasticized or unplasticized nylon which may be Nylon 6, 6/66, 6/12, 12, or, typically 11, may be preferred as providing the desired degree of chemical resistance. As used herein, “chemical resistance” should be understood to mean the ability to resist swelling, crazing, stress cracking, corrosion, or otherwise to withstand attack from gasoline, diesel fuel, and other engine fluids or hydrocarbons, as well as organic solvents such as methanol, and inorganic solvents such as water or brine. The specific nylon or other polyamide may be chosen for reasons of cost and/or for service temperature, chemical compatibility with the fluid being handled, fluid, solvent, moisture, or environmental resistance, flexural modulus, hardness, or other physical property, and typically will have a melting point of between about 175-235° C. and a thermal decomposition temperature of between about 195-280° C.

As to the polyolefin for the second thermoplastic material, again for airbrake tubing applications, a high density polyethylene (HDPE) may be preferred as being of a lower cost than the nylons conventionally used in such applications, and as additionally affording improvements in low temperature flexibility and old temperature impact resistance, and a reduction in coefficient of friction for easier installation of long tubing lengths. Alternatively, the polyolefin may be a lower modulus polyethylene, or another polyolefin such as a polypropylene or polybutylene.

The compatibilizer may be a copolymer of a polyolefin, such as a polyethylene or a polypropylene, and a polyamide. More particularly, the copolymer may be a graft copolymer formed of a polyolefin back and polyamide grafts. Compatibilizers of the type herein involved are further described in U.S. Pat. Appln. Publ. 2004/0030045.

The alloy of the present invention may be formulated, exclusive of any fillers, modifiers, additives, or other component, as blended or otherwise admixed of, for example, between about 50-85% by weight of the first thermoplastic material, between about 15-50% by weight of the second thermoplastic material, and between about 1-10% by weight of compatibilizer.

Looking next to FIG. 2, a multi-layer tubing construction incorporating member 10 of FIG. 1 is referenced generally at 20. Such construction 20 is formed as a 2-layer laminate of a tubular outermost layer, 22, and a tubular innermost layer, 24, formed by the member 10, which is concentric with the outermost layer 18, and which inner surface 16 thereof forms the innermost surface of the construction 20. Layer 22 also may be formed of a thermoplastic polymer material which may be formulated as the same alloy as described in connection with the member 10. Alternatively, layer 22 may be formed of a general purpose resin such as a polyester, polyurethane, or polyurethane. For airbrake tubing applications, however, layer 22 may be a polyamide or blend, and particularly a polyamide of the type commonly used in such applications, such as a plasticized or unplasticized nylon which may be Nylon 6, 6/66, 6/12, or, typically 11 or 12. As before, the material forming the layer 22 may be filled or unfilled, and may be a homo or copolymer, or a blend thereof, i.e., a blend of one or more homopolymers, one or more copolymers, or one or more homopolymers and one or more copolymers.

With the layers 22 and 24 each being formed of a thermoplastic material, the tubing construction 20 may be formed by continuous co-extrusion or other extrusion such as cross-head or sequential extrusion. Alternatively, the layers 22 and 24 may be molded or co-molded, or otherwise formed, such as via coating, or a combination of extrusion, molding, and/or coating. If formed of compatible materials, the layers 22 and 24 may be directly bonded together, such as by thermal fusion bonding, to form an integral, composite or laminate structure. Otherwise, if adjoining, the layers may be made into a composite via the use of an intermediate adhesive, tie, or other layer (not shown). Indeed, in other multi-layer construction, one or more additional layers, which may be the same as or different than the layers 22 and 24, may be provided in combination with those layers. Also, in any of the constructions, the layers may be reversed such that the outer surface 14 of the layer 24 forms the outermost surface of the construction.

Moreover, in a hose construction, one or more reinforcement or additional resin layers, or a cover or jacket (not shown), may be knitted, braided, woven, wound, or wrapped in the case of a fiber, wire, metal foil, tape, film, or the like, or, alternatively, extruded, molded, or coated such as in the case of an additional resin layer resin layer, on or about, or otherwise as surrounding the construction 20 which, in such instance, may function as a core tube for such hose. The materials forming the reinforcement, cover, or additional resin layers may be loaded with metals, carbon black, pigments, dyes, reflectants or another fillers in particulate, flake, fiber, or other form so as to render the such construction electrically-conductive for applications requiring electrical conductivity or static dissipation, and/or, depending upon the filler, for providing color coding or increased visibility. Separate electrically-conductive or reflective fiber or resin layers, wires, and other elements (not shown) also may be incorporated within, in, or on the multi-layer structure of the construction 20 such as to provide electrical conductivity, static dissipation, or increased visibility. The wall thicknesses of each of the layers 22 and 24 in the construction 20 may be of any thickness, both absolute and relative to the thickness of the other layer, but for many applications will be between about 5-250 mils (0.13-6.35 mm).

Turning lastly to FIG. 3, a representative 3-layer tubing construction incorporating member 10 of FIG. 1 is referenced generally at 30. Such construction 30 is similar to that of the construction 20, with the exception that one or more reinforcement layers, 32, is interposed between the layers 22 and 24. In this regard, each of the one or more reinforcement layers 32 may be braided, woven, wound, such as spiral or helically, knitted, wrapped, or otherwise formed successively about, i.e., as surrounding, outer surface 14 of the inner layer 24, with the outer layer 22 then being extruded or otherwise formed over the reinforcement layer or layers 32. Each of the reinforcement layers 32 may be formed, of one or more filaments, which may be monofilaments, continuous multi-filament, i.e., yarn, stranded, cord, roving, thread, tape, or ply, or short “staple” strands, of one or more fiber materials. The fiber material, which may be the same or different in each of the layers 32 which are provided, may be a natural or synthetic polymeric material such as a nylon, cotton, polyester, polyamide, aramid, polyolefin, polyvinyl alcohol (PVA), polyvinyl acetate, or polyphenylene bezobisoxazole (PBO), or blend, a steel, which may be stainless or galvanized, brass, zinc or zinc-plated, or other metal wire, or a blend thereof.

For airbrake tubing applications, and as is shown in FIG. 3, a single reinforcement layer 32 typically will be provided as braided of a nylon, polyester, or aramid filament or yarn, and as having a relatively open structure with interstices, one of which is referenced at 40, between the filaments, referenced at 42, of the braid. The outer layer 22 thereby may be fusion or otherwise bonded to the inner layer 24 through the interstices 40, with the reinforcement layer 32 itself being bonded to or between the layers 22 and 24 mechanically, such as by embedded in or encapsulated between the layers 22 and 24, or by other bonding means such as fusion, chemical, or adhesive bonding, or a combination thereof or otherwise. Such other bonding means may be effected by solvating, tackifying, or plasticizing the surfaces of the layers 22 and/or 24 with an appropriate solvent, such as a carboxylic or other organic acid, tackifier, or plasticizer such as an aqueous or other solution of an amine such as n-methyl pyrrolidone or a phenol such as meta-cresol or resorcinol, or with the use of a urethane, epoxy, vinyl chloride, vinyl acetate, methyl acrylic, or other adhesive having an affinity to the materials forming the layers 22 and 24, or otherwise in the manner described, for example, in U.S. Pat. Nos. 3,654,967; 3,682,201; 3,773,089; 3,790,419; 3,861,973; 3,881,975; 3,905,398; 3,914,146; 3,982,982; 3,988,188; 4,007,070; 4,064,913; 4,343,333; 4,898,212; and 6,807,988 and in the references cited therein, and in Japanese (Kokai) Publ. No. 10-169854 A2 and Canadian Pat. No. 973,074.

Thus, single and multi-layer tubing and hose constructions incorporating the tubular polymeric member of the present invention have been described.

As it is anticipated that certain changes may be made in the present invention without departing from the precepts herein involved, it is intended that all matter contained in the foregoing description shall be interpreted as illustrative and not in a limiting sense. All references including any priority documents cited herein are expressly incorporated by reference.

What is claimed is:

1. A tubular polymeric member formed of an alloy comprising a blend of:
a first thermoplastic material selected from the group consisting of polyamides and copolymers thereof;
a second thermoplastic material selected from the group consisting of polyolefins and copolymers thereof; and
a compatibilizer comprising a copolymer of one or more polyamides or polyamide copolymers and one or more polyolefins or polyolefin copolymers.

2. The tubular polymeric member of claim 1 wherein the first thermoplastic material is a nylon or a copolymer thereof.

3. The tubular polymeric member of claim 2 wherein the nylon is Nylon 11.

4. The tubular polymeric member of claim 1 wherein the second thermoplastic material is a polyethylene or a copolymer thereof.

5. The tubular polymeric member of claim 2 wherein the second thermoplastic material is a polyethylene or a copolymer thereof.

6. The tubular polymeric member of claim 1 wherein the copolymer which comprises the compatibilizer is a graft copolymer.

7. The tubular polymeric member of claim 6 wherein the graft copolymer is formed of a polyolefin backbone and polyamide grafts attached to the backbone.

8. An article comprising a tubular polymer member, the tubular polymeric composite member forming a tubular first layer within the member and being formed of an alloy comprising a blend of:
a first thermoplastic material selected from the group consisting of polyamides and copolymers thereof;
a second thermoplastic material selected from the group consisting of polyolefins and copolymers thereof; and
a compatibilizer comprising a copolymer of one or more polyamides or polyamide copolymers and one or more polyolefins or polyolefin copolymers.

9. The article of claim 8 further comprising:
a tubular second layer concentric with the first layer, the second layer being formed of a thermoplastic material different from the alloy forming the first layer.

10. The article of claim 9 wherein the thermoplastic material forming the second layer is a polyamide.

11. The article of claim 8 further comprising:
tubular reinforcement layer concentric with the first layer, the reinforcement layer formed of one or more filaments of one or more fibers.

12. The article of claim 8 wherein:
the article has an innermost surface and an outermost surface; and
the innermost surface of the article is formed by the first layer.

13. The article of claim 8 wherein:
the article has an innermost surface and an outermost surface; and
the outermost surface of the article is formed by the first layer.

14. The article of claim 8, 9, or 11 wherein the first thermoplastic material is a nylon or a copolymer thereof.

15. The article of claim 14 wherein the nylon is Nylon 11.

16. The article of claim 8, 9, or 11 wherein the second thermoplastic material is a polyethylene or a copolymer thereof.

17. The article of claim 16 wherein the first thermoplastic material is a nylon or a copolymer thereof.

18. The article of claim 8, 9, or 11 wherein the copolymer which comprises the compatibilizer is a graft copolymer.

19. The article of claim 18 wherein the graft copolymer is formed of a polyolefin backbone and polyamide grafts attached to the backbone.

20. The article of claim 19 wherein the first thermoplastic material is a nylon or a copolymer thereof.

21. The article of claim 20 wherein the second thermoplastic material is a polyethylene or a copolymer thereof.

22. The article of claim 19 wherein the second thermoplastic material is a polyethylene or a copolymer thereof.
